(19) United States
(12) Patent Application Publication
(10) Pub. No.: US 2005/0196319 A1
(43) Pub. Date: Sep. 8, 2005

(54) System and method for providing a reaction surface of a predetermined area for a limited volume

(75) Inventors: Karin L. Bogren, Fort Collins, CO (US); Stephen J. Takacs, Evans, CO (US); Douglas Ford Royer, Windsor, CO (US)

Correspondence Address: SETTER OLLILA, LLC, 2060 BROADWAY, SUITE 300, BOULDER, CO, 80302, US

(73) Assignee: HACH COMPANY

(21) Appl. No.: 10/945,193

(22) Filed: Sep. 20, 2004

Related U.S. Application Data
(60) Provisional application No. 60/549,742, filed on Mar. 3, 2004.

(51) Int. Cl. B01L 3/00

(52) U.S. Cl. 422/58; 422/102

(57) ABSTRACT

A cell for chemical analysis is disclosed that increases the surface area over standard discrete cells for approximately the same sample volume. The surface area is pre-coated with a reaction agent, enzyme, or chemical to facilitate testing of the sample. The cell may be in a configuration to contain any toxic reaction agent after use.

### RELATED APPLICATIONS

This application claims the benefit of U.S. provisional application No. 60/549,742 filed on Mar. 3, 2004 entitled “A System and Method for Providing a Reaction Surface of a Predetermined Area for a Limited Volume,” which hereby is incorporated by reference into this application.

### BACKGROUND OF THE INVENTION

1. Field of the Invention

The invention is related to the field of analyzers, and in particular, to discrete wet chemical analyzers.

2. Statement of the Problem

FIG. 1 shows a bench top discrete analyzer for wet chemistry. In typical discrete analyzers a sample is placed in the analyzer. The analyzer draws a small amount of the sample into a sample probe and transfers it to a reaction well. Each reaction well may contain a cell where the reaction takes place. A cell is typically a small container or cup or flowcell configured to hold the sample and any reagents used in the chemical reaction. The cell may be disposable or may be reusable after reconditioning. Once the sample has been transferred to the cell, the analyzer rinses the sample probe and then draws any reagents needed for the reaction, from the reagent reservoirs, and transfers the reagent to the reaction cell. The analyzer may stir the sample and reagent, using the sample probe, to aid in the reaction. Once sufficient time has passed for the reaction to occur, the analyzer transfers the mixture to a flow cell where it will be moved into the testing area and tested for the results of the reaction. Some reactions require the sample to be pre-conditioned before a reagent is added for a reaction. For example, in the cadmium reduction method, the sample must be exposed to a cadmium source before being combined with the color forming reagents. In the cadmium reduction method, the amount of preconditioning for a given sample size is a function of the surface area of the cadmium source per volume of sample and the time of exposure to the source. In some analyzers, the sample is passed through a long thin tube or coil where the inside of the tube has been coated with cadmium. This tends to maximize the surface area of the cadmium source for the give sample size. In some analyzers, the cadmium source is placed inline with the sample probe, such that every sample drawn into the sample probe passes through the cadmium source. FIG. 2 shows a bench top discrete analyzer for wet chemistry with a cadmium coil mounted inline with the sample and reagent probe.

Putting the cadmium source inline with the sample probe has a number of disadvantages. With the cadmium source inline, every sample transferred through the sample probe passes through the cadmium source. Most discrete analyzers do more than one type of test. If the test does not need the preconditioning step, or can't tolerate being exposed to cadmium, the analyzer may not be able to run the test in the inline configuration. Another problem with the inline cadmium source is that the cadmium source may become contaminated by the transfer of a sample to the reaction well. The cadmium source may also have a limited life. Once the cadmium has been depleted, the source must be reconditioned or replaced before more testing can be performed. In the inline configuration, the analyzer can not be used for any type of testing while the cadmium source is being cleaned or reconditioned.

Therefore there is a need for a system and method for providing a better solution for preconditioning samples.

### SUMMARY OF THE INVENTION

A cell for chemical analysis is disclosed that increases the surface area over standard discrete cells for approximately the same sample volume. The surface area is pre-coated with a reaction agent, enzyme, or chemical to facilitate testing of the sample. The cell may be in a configuration to contain any toxic reaction agent after use.

### BRIEF DESCRIPTION OF THE DRAWINGS

FIG. 1 is an isometric view of a discrete bench top analyzer.

FIG. 2 is an isometric view of a discrete bench top analyzer with an inline cadmium coil.

FIG. 3 is an isometric view of a sample cell.

FIG. 4 is a top view of a cell with vertical ribs in an example embodiment of the invention.

FIG. 5 is a side view of a cell with threaded ribs in an example embodiment of the invention.

FIG. 6 is a sectional view of a cell with horizontal ribs in an example embodiment of the invention.

FIG. 7 is a drawing of an insert with tilted vertical ribs in an example embodiment of the invention.

FIG. 8 is a top view of an insert with tilted vertical ribs showing the direction for stirring in an example embodiment of the invention.

FIG. 9 is a drawing of an insert cell assembly in an example embodiment of the invention.

FIG. 10 is a isometric view of an insert cell assembly in an example embodiment of the invention.

### DETAILED DESCRIPTION OF THE PREFERRED EMBODIMENT

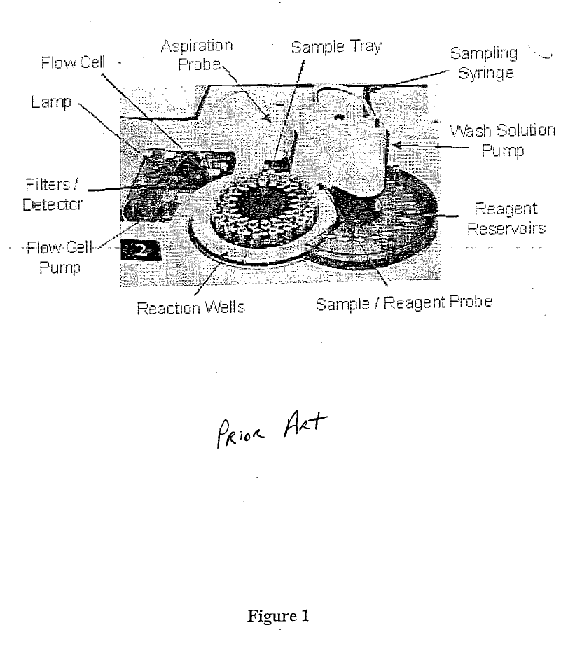

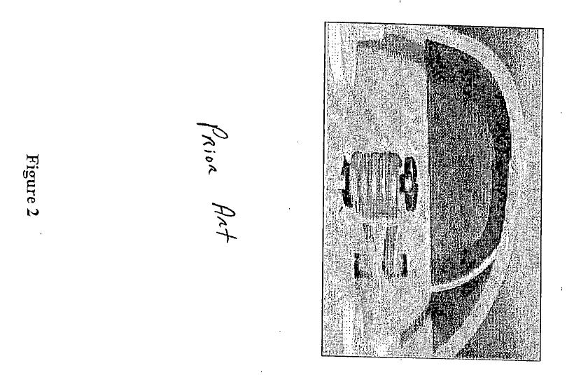

FIGS. 1-8 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

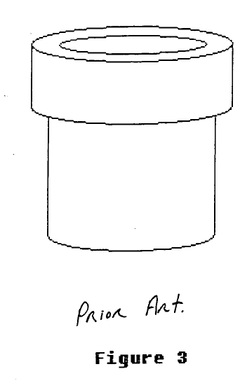

When doing discrete tests in an analyzer, preconditioning the sample using an inline source has a number of disadvantages as discussed above. One way to overcome these disadvantages is to move the preconditioning source into a sample aspiration cup. Unfortunately, the typical cell does not contain enough surface area for the sample volume to provide the proper preconditioning in the time needed. FIG. 3 is an isometric view of a typical sample cell. The discrete analyzer where the cell will be used determines the height and diameter of the sample cell being used. This is typically dependent on the volume of the sample required for testing as well as the amount of the reagents needed for the reaction. The sample probe diameter and the stirring radius determine the minimum inner diameter of the sample cell used in the analyzer.

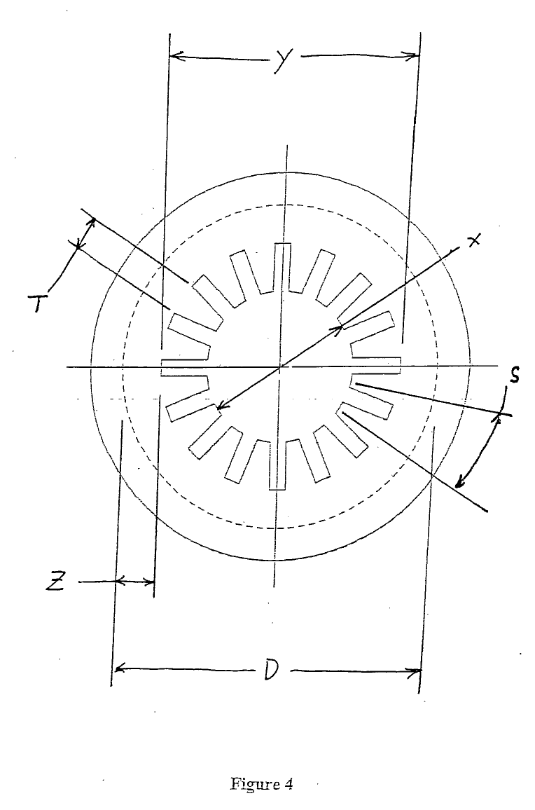

In one example embodiment of the invention, the geometry of the cell has been changed to increase the surface area of the container. One way to increase the surface area is to include vertical ribs that are attached to the inside of the cell wall, angled to the inside of the cell. FIG. 4 is a top view of the cell with such ribs. The length of the ribs is determined by a minimum inner diameter X and the maximum outer diameter Y. The maximum outer diameter Y is determined by the cell outer diameter D and the minimum cell wall thickness Z. In the preferred embodiment, the minimum inner diameter is determined by the probe diameter and the stirring radius of the sample probe in the analyzer. The rib thickness T and the rib spacing S can be varied to increase or decrease the amount of surface area in the cell. By increasing the surface area of the cell, the reaction can be moved from the inline source to a reaction in the cell. One advantage is that the reaction time can now be controlled by how long the sample is left in the cell. Using an inline source the reaction time is controlled by trying to control the flow rate an d length of travel through the inline source.

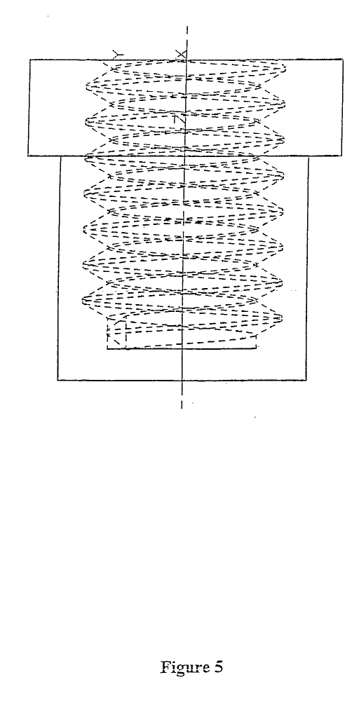

In another example embodiment, the cell geometry has been changed by adding a screw thread feature to the inside of the cell. FIG. 5 is a side view of such a cell. The thread depth is determined by the maximum outer diameter. The thread inner diameter is determined by the probe diameter and the stirring radius of the sample probe in the analyzer. The pitch of the thread may be varied to increase or decrease the amount of surface area provided by the cell. The screw thread may be any type of thread, for example: square thread, Whitworth thread, Acme thread, pipe thread, or the like. The screw thread may be a single thread or multiple threads.

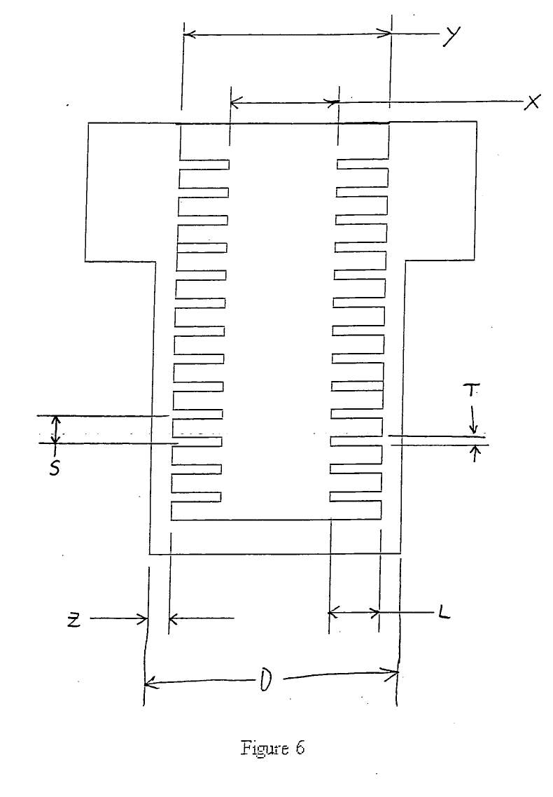

In another example embodiment, ribs may be added to the cell where the ribs are spaced horizontally. FIG. 6 is a sectional view of such a cell. The length of the ribs is determined by a minimum inner diameter X and the maximum outer diameter Y. The maximum outer diameter Y is determined by the cell outer diameter D and the minimum cell wall thickness Z. The minimum inner diameter is determined by the probe diameter and the stirring radius of the sample probe in the analyzer. The rib thickness T and the rib spacing S can be varied to increase or decrease the amount of surface area in the cell.

The different geometry of the cells have different advantages. Some geometry's are easier to manufacture than others. For example, a cell using vertical ribs (FIG. 4) may be easier to manufacture than a cell using horizontal ribs (FIG. 6). The mold for the vertical ribs can be pulled straight off where a mold for the horizontal ribs may need movable inserts. A mold for the screw design may be removed with a screwing motion. Some of the advantages may be functional. For example, some geometries may provide better mixing properties for the reagents as the mixture is stirred with the sample probe. Some geometries may provide better mixing when used in a portable tester where the sample is shaken, not stirred. Some geometries may provide better access to the sample. For example, in a portable tester the sample may be transferred to the testing area by being poured out of the reaction cell. In this case having horizontal ribs may restrict the access to the sample by trapping some of the sample within the reaction cell.

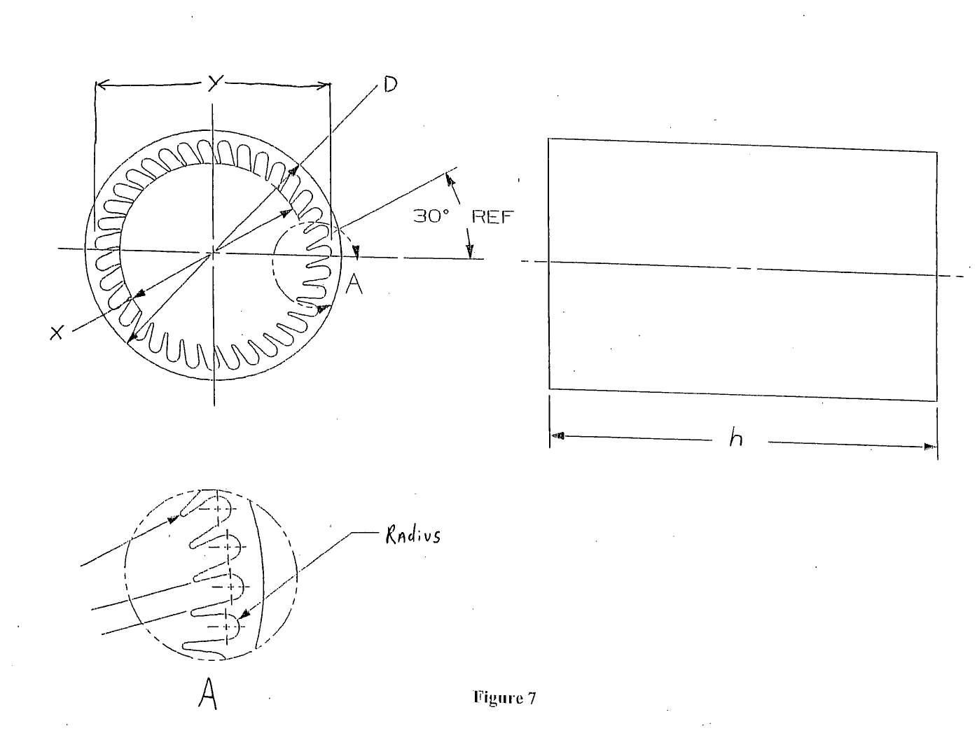

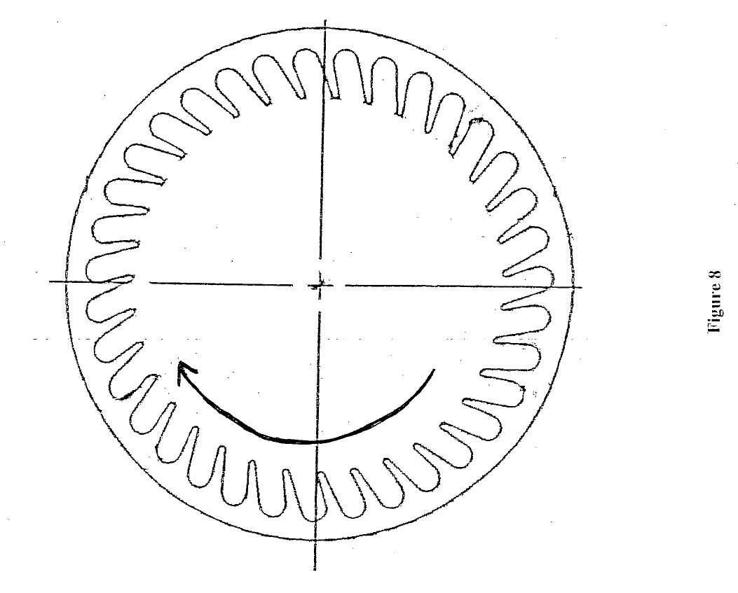

When the cell is to be used in an analyzer that may stir the sample using the sample probe, some rib geometries may work better than others. A vertical rib design as shown in FIG. 4 may tend to trap fluid inside the spacing between the ribs as the sample probe passes by. In a preferred embodiment the vertical ribs are tilted away from being perpendicular to the cell wall (See FIG. 7). The tilt is in the direction of probe movement (see FIG. 8). As the probe passes by a tilted rib, the probe motion tends to suck the fluid from between the ribs, increasing the exposure rate of the sample to the surface area of the cell wall. In the preferred embodiment, the ribs are tilted by 30 degrees from perpendicular. In the preferred embodiment, the geometry of the rib base has been configured as a radius that smoothly couples two adjacent ribs. The smooth shape between the ribs promotes fluid flow of the sample when being stirred by the sample probe. Any shape that smoothly couples the two ribs may be used. The rib thickness and rib spacing have been chosen to provide a predetermined surface area for a given cell size. In the preferred embodiment, the rib geometry provides approximately 728 square millimeters of area for a 500 micro-liter sample volume. FIG. 7 and FIG. 8 show a rib spacing where the gap between two ribs is constant causing a rib with a base slightly wider than the tip. This allows a manufacturing method where the cutters used to form the ribs have a uniform thickness. In other embodiments the rib thickness may be constant and the gap between the ribs may vary between the rib base and the rib tip.

The type of test to be performed on the sample determines the type of active material used to coat the surface of the cell. For example, for a nitrate test, cadmium may be used to reduce the nitrate to nitrite. In this example, cadmium would be attached to the surface of the cell. The cells are typically made of a plastic material, but may be made from steel, copper, brass, or the like. The active material may be attached to the surface of the cell using a number of different processes, for example immobilization, adhesion, or chemical bonding. In some cases the active material may be toxic. In these cases it may be preferable to limit the coating of the active material to only the inner portion of the cuvette or cell. Attaching a material, or coating a material, to only a portion of the total surface area of a part may be more expensive than coating the entire surface area of the part, due to the amount of masking that may be required.

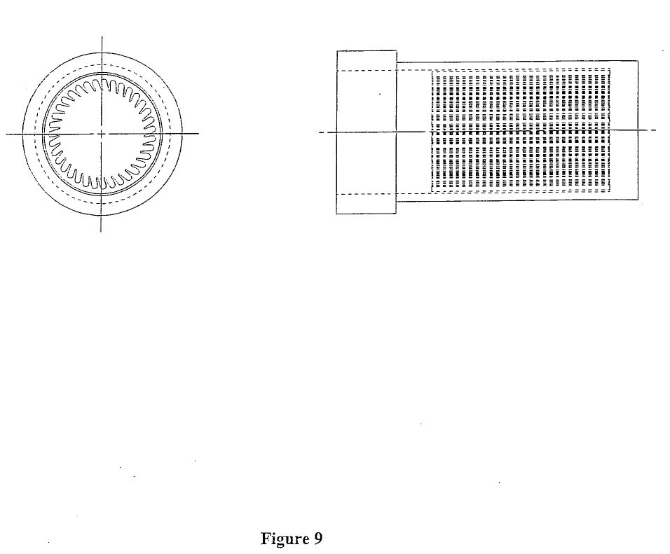

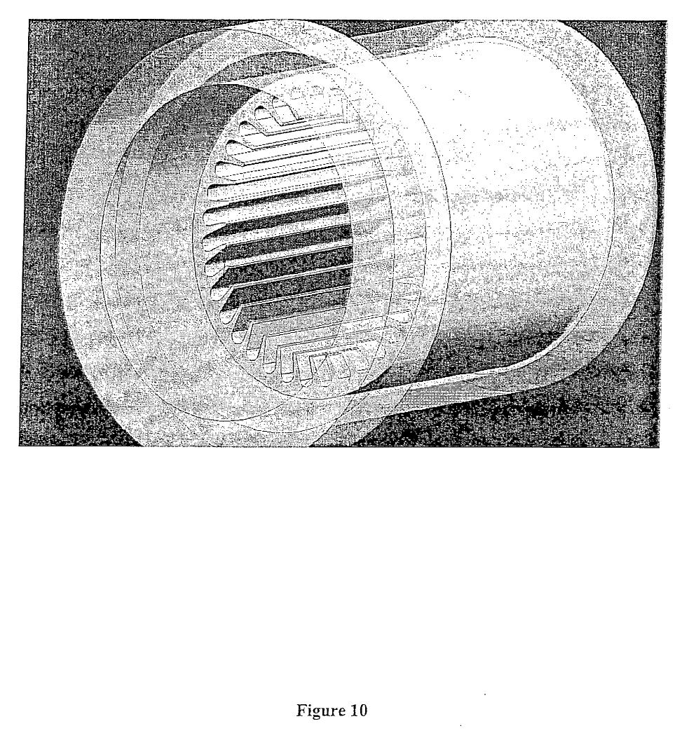

In a preferred embodiment of the invention, an insert will be used to increase the surface area of the cell. The insert will have an inner geometry that increases the surface area used in a reaction. The outer surface of the insert will be configured to fit inside a cell. FIG. 7 is a drawing of an insert in an example embodiment of the invention. The outer diameter of the insert may be configured to fit into a standard sized cell, or the cell dimensions may be adjusted to accommodate the insert to match a standard volume requirement. The insert will be coated with an active material and then installed into the cell (see FIG. 9). In this way the entire insert may be coated or platted, but the outer surface of the insert will be protected from exposure to the environment by the inner surface of the cell (see FIGS. 9 and 10). The insert may be made from a wide verity of materials, for example, plastic, steel, copper, brass, or the like. The insert may be configured to be removed from the cell, such that the insert may be reconditioned and then reused.

In one example embodiment of the invention, the insert will be configured with a feature that prevents assembly of the insert into the cell in the incorrect orientation. The incorrect orientation is when the tilt of the ribs is facing the stirring direction instead of pointing away from the stirring direction. When the insert is installed into the cell with one end down, the ribs will be in the correct orientation. When the other end of the insert is installed first, the ribs would be facing in the wrong direction. One example of a feature to prevent incorrect insertion is a lip or flange on one end of the insert. The lip or flange would prevent the insertion of the wrong end of the insert into the cell.

Some of the active materials used in the reactions may be toxic. In one example embodiment of the invention, the cell would be configured with a cap or lid to seal the active material, contained on the cell interior or on the insert, to prevent exposure to the environment.

1. An apparatus, comprising:
a sample cup, the sample cup having a pocket configured to hold fluids, the pocket formed from a side wall and a floor;
a surface, formed by the side wall, where the surface does not form a smooth cylindrical shape or a smooth conical shape;
the surface of the side wall having a surface area that is larger than the surface area of a side wall having a smooth cylindrical or smooth conical shape;
the surface area of the side wall having an active surface.

2. The apparatus of claim 1 where the surface of the side wall is a corrugated shape.

3. The apparatus of claim 1 where the surface of the side wall forms a screw thread.

4. The apparatus of claim 1 where the surface of the side wall is approximately a cylindrical shape having a plurality of ribs.

5. The apparatus of claim 4 where the ribs are vertical.

6. The apparatus of claim 5 where the vertical ribs are tilted at an angle from perpendicular with respect to the cylindrical surface of the side wall.

7. The apparatus of claim 6 where the direction of tilt is in a stirring direction for a sample probe.

8. The apparatus of claim 1 where the side wall of the pocket is formed by an insert fitted into the sample cup.

9. An insert configured to fit into a sample cup, comprising:
a hollow tube having both ends open, the hollow tube having an outer surface and an inner surface;
the outer surface sized to fit into a sample cup;
the inner surface having a shape that is not a smooth cylindrical shape or a smooth conical shape;
the inner surface having a surface area that is larger than the surface area of a smooth cylindrical shape or a smooth conical shape;
the inner surface area having an active surface.

10. The insert of claim 9 where the inner surface is a corrugated shape.

11. The insert of claim 9 where the inner surface forms a screw thread.

12. The insert of claim 9 where the inner surface is approximately a cylindrical shape having a plurality of ribs.

13. The insert of claim 12 where the ribs are vertical.

14. The insert of claim 13 where the vertical ribs are tilted at an angle from perpendicular with respect to the cylindrical surface of the inner surface.

15. The insert of claim 14 where the direction of tilt is in a stirring direction for a sample probe.

16. The insert of claim 15 where the outer surface of a first end of the tube forms a lip that prevents the first end of the tube from being inserted into a sample cup.

17. The insert of claim 14 where the angle of tilt is approximately 30 degrees.

18. The insert of claim 9 where the active surface is cadmium.

19. A method for manufacturing an insert, comprising:
forming a tube having an outer surface and an inner surface, the outer surface sized to fit in a sample cup, the inner surface having a corrugated shape;
coating the tube with an active material.

20. The method of claim 19 further comprising:
cutting the tube into a plurality of segments where the length of the segments are sized to fit in a sample cup.

21. A sample cup, comprising:
a means for exposing a fluid sample to a large surface area relative to the fluid sample volume;
the large surface area having an active surface.
